(19) United States
(12) Patent Application Publication
(10) Pub. No.: US 2023/0306091 A1
(43) Pub. Date: Sep. 28, 2023

(54) METHOD AND DEVICE FOR DETECTING FUZZING ANALYSIS ON AN ELECTRONIC DEVICE

(71) Applicant: NXP B.V., Eindhoven (NL)

(72) Inventor: Nikita Veshchikov, Brussels (BE)

(21) Appl. No.: 17/656,020

(22) Filed: Mar. 23, 2022

(51) Int. Cl. G06F 21/14; G06F 21/76; G06N 3/04

(52) U.S. Cl. CPC G06F 21/14; G06F 21/76; G06N 3/0436

(57) ABSTRACT

A method is provided for detecting a fuzzing analysis in a device. In the method, a new message of a message type is received from a second device. The message type of the new message is predicted from previously received messages. In one embodiment, the prediction is performed using a machine learning model. Also, the message type of the new message is determined. The message type may be determined by decoding and parsing the new message using instruction execution circuitry of a processor. A likelihood that the predicted message type compares favorably to the determined message type of the new message is computed. In another embodiment, a lookup table of likely subsequent messages to previously received messages is stored in the first electronic device. If it is determined that the predicted message type does not compare favorably to a threshold likelihood value, an indication of a fuzzing attack is indicated.

### BACKGROUND

### Field

This disclosure generally relates to electronic circuits, and more particularly, to a method for detecting a fuzzing analysis on an electronic circuit.

### Related Art

There are many protocols that facilitate communication between electronic devices. Example communication protocols include USB, Bluetooth, Wifi, and near field communication (NFC). The protocol in one device interacts with a counterpart program in another device to facilitate communications. Application programs also often interact with each other using protocols as well as Application Programming Interfaces (APIs). The protocols and other programs interact using a set of structured messages such as commands and instructions that can be exchanged between two devices to obtain information or access services. An attacker can also try to interact with a device (or a program) using any of the protocols that the device expects. An attacker may try to craft a malicious message that does not exactly follow the rules of a protocol using a technique called fuzzing. Using information gained from a fuzzing analysis, the attacker may try to create a fault or exploit a bug or error in the program code of the attacked device to gain control or access to the device.

Therefore, what is needed is a method for detecting a fuzzing analysis performed by an attacker on a device.

### BRIEF DESCRIPTION OF THE DRAWINGS

The present invention is illustrated by way of example and is not limited by the accompanying figures, in which like references indicate similar elements. Elements in the figures are illustrated for simplicity and clarity and have not necessarily been drawn to scale.

FIG. 1 illustrates a simplified block diagram of a fuzzing attack against a device.

FIG. 2 illustrates a state diagram of a device following a simplified example protocol.

FIG. 3 illustrates a method for fuzzing detection in accordance with an embodiment.

FIG. 4 illustrates a table of an example likelihood distribution of new request types in view of previously received request types.

FIG. 5 illustrates a flowchart of a method for fuzzing detection in accordance with an embodiment.

FIG. 6 illustrates a data processing system useful for implementing a device in accordance with an embodiment.

### DETAILED DESCRIPTION

Generally, there is provided, a mechanism to detect a fuzzing analysis on a first electronic device or a program operating in the first electronic device. In the method, a new message having a message type is received from a second electronic device. The message type of the new message is predicted from previously received messages. In one embodiment, the prediction is performed using a machine learning model. Also, the message type of the new message is determined by analyzing bits of the new message using circuitry available in a processor of the device for fetching, decoding, parsing, and executing instructions. Then, a likelihood that the predicted message type of the new message compares favorably to the determined message type of the new message is computed. If it is determined that the predicted message type does not compare favorably to a threshold likelihood value, an indication of an ongoing fuzzing analysis is indicated, and appropriate action may be taken. If it is determined that the predicted message type does compare favorably to the threshold likelihood value, normal operations may be continued including responding to the new message. In another embodiment, a lookup table of likely subsequent messages based on previously received messages is precomputed and stored in the first electronic device.

Detecting a fuzzing analysis by an attacker that is underway allows a reaction to the attack that can undermine the efforts of the attacker. For example, steps may be taken to slow down the fuzzing attack or disable some parts of the protocol in the device under attack. Additional checks and countermeasures may be enabled. For example, a server may be alerted of the attack, the device may be rebooted, the device’s firmware may be erased, or some other actions may be performed to discourage and slow down the attacker.

In accordance with an embodiment, there is provided, a method for detecting a fuzzing analysis in a first device, the method including: receiving a new message of a message type from a second device; predicting the message type of the new message from previously received messages; determining the message type of the new message by analyzing the new message; determining a likelihood that the predicted message type compares favorably to the determined message type of the new message; determining that the predicted message type does not compare favorably to a threshold likelihood value; and providing an indication of the fuzzing attack. The method may further include adding the determined message type of the new message to a stored list of previous messages in a memory of the first device. Predicting the message type of the new message may be performed using a machine learning model in the first device. The machine learning model may include a long short-term memory (LSTM) neural network. The indication of the fuzzing attack may be provided only after a plurality of unfavorable comparisons to the threshold likelihood value. The method may be implemented in a program including instructions stored in a non-transient storage medium and executed by a processor in the first device. The method may be capable of being disabled during software development in the first device. The message type of the new message may be a request for data. The new message may be a malformed request for data, and wherein the malformed request for data may have a relatively low likelihood value. Fuzzing analysis detection may be enabled or disabled using a control bit stored in a memory.

In another embodiment, there is provided, a method for detecting a fuzzing analysis in a first device, the method including: receiving a new message having a message type from a second device; predicting the message type of the new message from previously received messages; determining the message type of the new message by analyzing the new message; determining a likelihood that the predicted message type compares favorably to the determined message type of the new message; adding the determined message type of the new message to a stored list of previous messages in a memory of the first device; determining that the predicted message type does not compare favorably to a threshold likelihood value; and providing an indication of the fuzzing attack. Predicting the message type of the new message may be performed using a machine learning model in the first device. The machine learning model may include a long short-term memory (LSTM) neural network. The indication of the fuzzing analysis may be provided only after a plurality of unfavorable comparisons to the threshold likelihood value. The method may be implemented in a program including instructions stored in a non-transient storage medium and executed by a processor in the first device. The method may be capable of being disabled during software development in the first device. The message type of the new message may be a request for data. The new message may be a malformed request for data, and wherein the malformed request for data has a relatively low likelihood value. Fuzzing analysis detection may be enabled or disabled using a control bit stored in a memory. Determining the message type of the new message by analyzing the new message may further include using instruction execution circuitry of a processor to decode the new message to determine the message type.

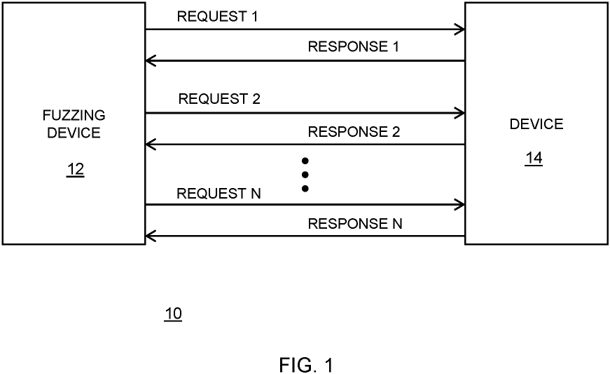

FIG. 1 illustrates a simplified block diagram of a fuzzing attack by fuzzing device 12 against another device 14. Fuzzing is a technique commonly used by program developers to discover bugs or abnormal behaviors in devices and programs. The main idea behind fuzzing is to follow the expected protocol during a communication between the devices while introducing random mutations (modifications) to the exchanged messages. The mutations may include random bit flips in messages, and changes in the order of messages or parts of a message. Normally, a device under fuzz testing should detect an error in a message sent by the fuzzing device the moment the message with an error is received. When the error is detected, the device under test should notify the message sender of the error in the message. However, if the device does not detect an error in the request message then it may get into an incoherent state such as deadlock or the device may “crash”. Incoherent states that can lead to the crash of the device are often exploited by an attacker. If such problems are not discovered during the device manufacturing, they might be discovered by an attacker.

In the example of FIG. 1, device 12 is a fuzzing device sending many different requests, such as requests for data, and the other device 14 is undergoing a fuzzing analysis by device 12 and may be, for example, a service provider that sends responses to the requests. For the purposes of clarity and simplicity FIG. 1 provides an example of two devices using a very simple protocol for communication. Device 12 sends requests REQUEST 1 - N and device 14 responds to each request with a corresponding response of responses RESPONSE 1 - N. A similar setup can be done by an attacker to analyze a device that requests services. In addition to the requests and responses, an error message may also be sent to device 12 if a problem occurs during the handling of a request or if a request is not correctly formatted. These types of errors can be found by an attacker who uses a fuzzing technique such as illustrated in FIG. 1 to discover vulnerabilities in a device or program.

Before attacking a device, a hacker needs to know how to craft a malicious message that can be used to exploit a bug in the code. If the source code of the implementation is available to the attacker, the attacker may analyze the source code to find a bug that can be used for an attack. However, the source code of the implementation of many protocols (for a given specific device) is rarely available for commercial products. In such case the attacker may use fuzzing, or fuzz-testing, to discover bugs in the implementation of the target device. A fuzzing analysis performed by an attacker can be successful even without having details of the implementation such as hardware schematics or the source code. Sometimes even a tested piece of code will have some uncaught errors.

Fuzzing analysis detection can be applied to a variety of different use cases and scenarios. For example, fuzzing analysis detection can be applied to most devices that include programs that communicate with other devices such as smartphones, smartcards, card readers, servers, internet of things (IoT) devices, household appliances, automobiles, etc. In terms of ways of communicating, fuzzing detection can be applied to files being used as inputs, messages of a protocol being parsed by a program, a request sent using an API, etc.

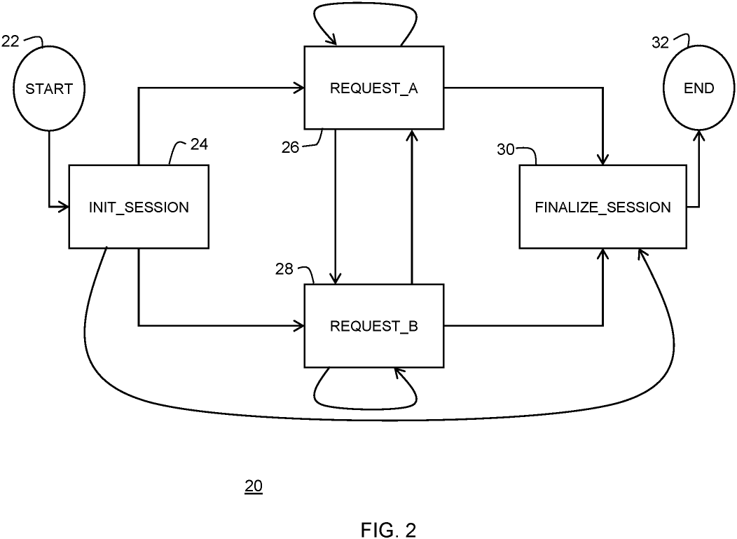

FIG. 2 illustrates a state diagram of a device following a simplified example protocol. As can be seen in FIG. 2, there are four different types of normal requests that a device can send to another device: INIT_SESSION, FINILIZE_ SESSION, REQUEST_A, REQUEST _B, and a fifth malformed request (not shown). Similarly, assume that another device (not shown) can respond with five types of messages: INIT _RESPONSE, FINALIZE_RESPONSE, RESPONSE_A, RESPONSE_B AND ERROR. To start a session at start oval 22, the device has to send an INIT_SESSION request 24, then it can send requests REQUEST_A 26 and REQUEST_B 28 types of messages any number of times. At any moment, the device can send a FINALIZE_SESSION 30 message to end the session at end oval 32.

Continuing with the above example, from the point of view of the device receiving the requests, in the case of a detected malformed request the device B will answer with an error message. In case of a bug in the program that may make the device miss the error in the malformed request, the device receiving the request may crash or go to an incoherent state. The order in which these messages arrive in a normal scenario for a legitimate device is not completely random. In other words, it is more likely to get a specific type of a request subsequent to certain previously received types of requests. It is expected that at least some of the malformed requests from a fuzzing analysis by an attacker can be detected by the code, and that the implementation of the device is not so bad that the device crashes immediately once any small error is present in a request.

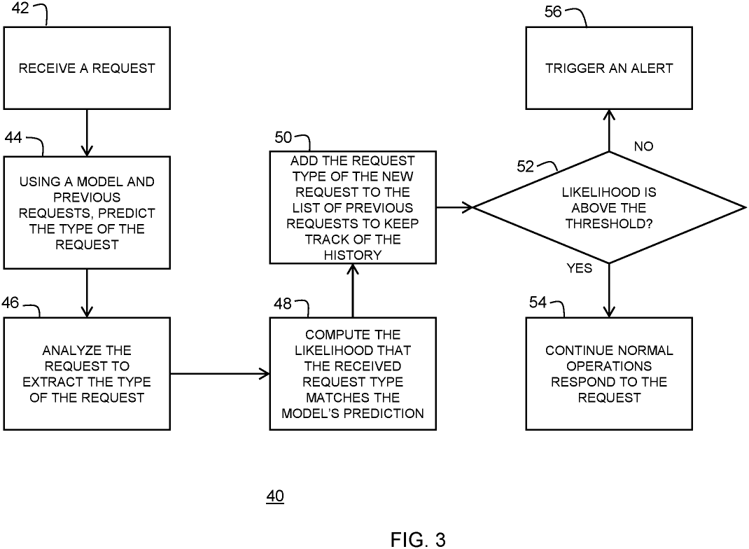

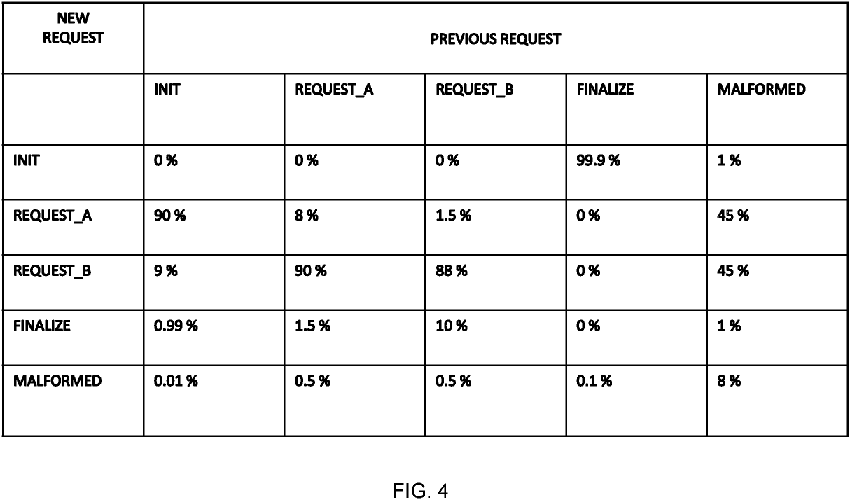

FIG. 3 illustrates method 40 for fuzzing analysis detection in accordance with an embodiment. Method 40 begins at step 42. At step 42, a device receives a message that may include a request. The message may include an instruction that is executed by a processor. At step 44, the device predicts the message type of request. To make a prediction regarding the type of request, the device may use requests that were previously received by the device. The device may also use a machine learning model trained using the previous requests to make the prediction. The machine learning model may use the request as an input during inference operation. In one embodiment, the machine learning model may include a Long Short-Term Memory (LSTM) neural network. At step 46, the request is analyzed by the device to determine what the message type is. This can be done using the normal processor circuitry for decoding and parsing a message for execution by the processor. At step 48, a likelihood is computed that the received message type matches the prediction of the machine learning model. In one embodiment, the prediction likelihoods may be precomputed and stored in a look up table such as the example look up table in FIG. 4. At step 50, the new request and the new request type are added to a list of previous requests. The list may be stored in a memory of the device and used for further predictions. At decision step 52, it is determined if the likelihood predicted in step 44 is above a threshold likelihood value. If the predicted likelihood is above the threshold likelihood value, the YES path is taken to step 54, the actual message type processed by the device corresponds with the predicted message type, and normal processing continues. However, if at step 52 the predicted likelihood is below the threshold likelihood value, then the message may be a result of an ongoing fuzzing analysis and an alert or other response may be triggered. The decision threshold for the threshold likelihood value can be set up by the device manufacturer and depends on the application of the device and its complexity. The likelihood threshold may be computed in many ways and may be static or updateable. Also, the threshold may be based only on previous requests, or on requests and responses to the requests. The type of action to be performed in response to a triggered alert can also be decided by the developer. Instead of a binary decision to trigger or not to trigger an alert, there could be several thresholds and several levels of alerts that correspond to, for example, “possible fuzzing”, “likely fuzzing” and “highly likely fuzzing”. Actions can be different depending on the level of this alert.

A model that can predict the type of the next request can be built in a lab by observing normal device communication conditions and can also be updated on the fly after a period of data collection from all devices. For example, all devices would send data about types of requests that they received to a server, the server would build the model based on data from all devices and then it can ship it back for use by the devices to predict the message types.

Once the fuzzing analysis is detected the device under analysis can react to undermine the efforts of the attacker and slow down the fuzzing analysis. For example, some types of queries may be forbidden, or some parts of the protocol may be disabled. Also, additional checks and countermeasures may be enabled. For example, a dedicated countermeasure server or part of a server may be alerted. The device may be rebooted or reset, firmware in the device may be erased, or some other action may be performed that is designed to discourage and slow down the attacker. The device can reset to factory settings. The device can erase its memory. Either some of the device configuration, or the entire firmware or even the cryptographic materials embedded in the device may be erased. The device can send a fake response message instead of following the standard expected protocol. The device can also send a message to a special dedicated server and alert it that one of the devices might be under attack or under investigation by a hacker. The device can also ask the user to perform some additional tasks to prove that the user is legitimate, e.g., the user may be asked to authenticate, solve a CAPTCHA or ask the user to prove that he is not a bot in any other way. Such actions that can only be done by humans will seriously slow down any attempt at fuzzing the device. This way an attacker who tries to use fuzzing against a device will have to spend much more effort to discover a bug that can be exploited, and the attacker may be discouraged from continuing the attack.

Instead of taking actions immediately, the device may be set to react to alerts only if a predetermined number of alert raising events occur within a relatively short time frame. This technique can reduce undesirable reactions to false alerts. Note, that the fuzzing detection mechanism, or at least actions taken upon detection should have a mechanism for being disabled because legitimate software developers and testers can use fuzzing during the development phase of a device. One way to disable the fuzzing mechanism may be to assign a bit in a register that can be controlled to enable or disable fuzzing detection. The register may be a secure register or memory location.

FIG. 4 illustrates a table of a simple example likelihood distribution of new request types in view of previously received requests types. The example protocol provided above in FIG. 2 is used to create the table. The prediction mechanism can be based on a model similar to language models that can predict the likelihood of the next word in a phrase given previous words. Such models can be built using machine learning techniques such as e.g., LSTM networks (long short-term memory networks). But it is also possible to build a very simple model based on a matrix such as the look up table shown in FIG. 4. In this model only one previous message is used to compute a prediction for a subsequent request. It is possible to analyze more previous requests, and even responses to the requests, to compute a more accurate table. In this example, a normal (most frequent) use of the example protocol of FIG. 2 may follow a scenario where a device initializes a session with INIT, makes a request REQUEST A followed by many requests REQUEST B followed by the finalization FINALIZE of the session.

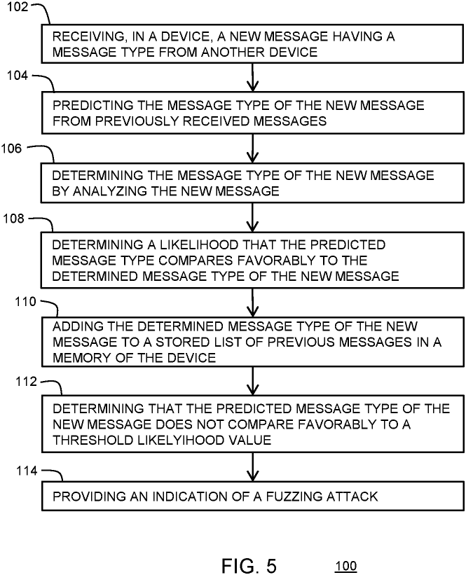

FIG. 5 illustrates a flowchart of method 100 for fuzzing analysis detection in accordance with an embodiment. Method 100 begins at step 102. At step 102, a new message is received by a device from another device. The new message has a message type. At step 104, the message type of the new message is predicted from messages previously received by the device. At step 106, the message type of the new message is determined by analyzing the new message using normal instruction processing circuitry of a processor in the device to parse and decode the message for execution. At step 108, a likelihood that the predicted message type from step 104 compares favorably to the determined message type from step 106 of the new message is computed. At step 110, the determined message type of the new message is added to a stored list of previous messages in a memory of the device. At step 112, it is determined that the predicted message type of the new message does not compare favorably to a threshold likelihood value indicating a possible ongoing fuzzing analysis. At step 114, an indication of the fuzzing analysis is provided.

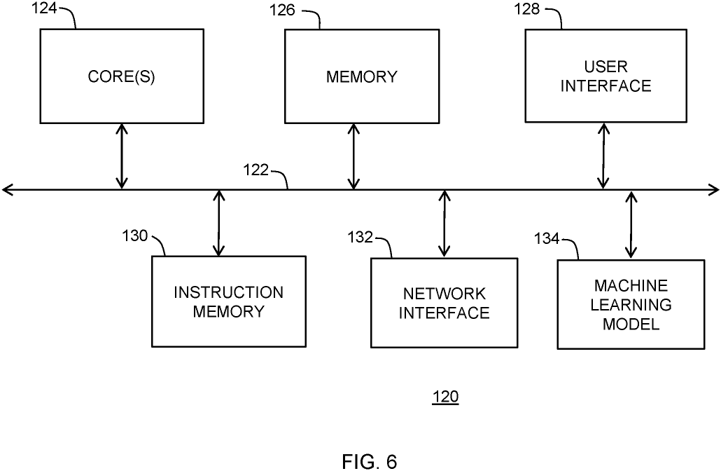

FIG. 6 illustrates data processing system 120 useful for implementing an electronic device, and in particular, device 14 from FIG. 1 in accordance with an embodiment. Data processing system 120 may be implemented using one or more integrated circuits and may be used in an implementation of the described embodiments. Data processing system 120 includes bus or switching network 122. Connected to bus 122 is one or more processor cores 124, memory 126, user interface 128, instruction memory 130, network interface 132, and machine learning model 134. The one or more processor cores 124 may include any hardware device capable of executing instructions stored in memory 126 or instruction memory 130. For example, processor cores 124 may decode and parse new messages to determine message types using circuitry for decoding and parsing instructions that processor cores 124 uses for normal execution of instructions. Processor cores 124 may be, for example, a microprocessor, field programmable gate array (FPGA), application-specific integrated circuit (ASIC), or similar device. Processor cores 124 may be implemented in a secure hardware element and may be tamper resistant.

Memory 126 may be any kind of memory, such as for example, L1, L2, or L3 cache or system memory. Memory 126 may include volatile memory such as static random-access memory (SRAM) or dynamic RAM (DRAM), or may include non-volatile memory such as flash memory, read only memory (ROM), or other volatile or non-volatile memory. Also, memory 126 may be implemented in a secure hardware element or other type of secure storage. Alternately, memory 126 may be a hard drive implemented externally to data processing system 120 or a register file. In one embodiment, memory 126 may be used to store a look up table for message type prediction and likelihood, or data useful for computing message type predictions.

User interface 128 may be connected to one or more devices for enabling communication with a user such as an administrator. For example, user interface 128 may be enabled for coupling to a display, a mouse, a keyboard, or other input/output device. Network interface 132 may include one or more devices for enabling communication with other hardware devices. For example, network interface 132 may include, or be coupled to, a network interface card (NIC) configured to communicate according to the Ethernet protocol. Also, network interface 132 may implement a TCP/IP stack for communication according to the TCP/IP protocols. Data samples for classification may be input via network interface 132, or similar interface. Various other hardware or configurations for communicating are available.

Instruction memory 130 may include one or more non-transient machine-readable storage media for storing instructions for execution by processor cores 124. In other embodiments, both memories 126 and 130 may store data upon which processor cores 124 may operate. Memories 126 and 130 may also store, for example, encryption, decryption, and verification applications. Memories 126 and 130 may be implemented in a secure hardware element and be tamper resistant.

Machine learning model 134 may be implemented in hardware, software, or a combination of hardware and software. Machine learning model 134 computes predictions for message types of newly received messages using previously received messages, responses to the previously received messages, or other information regarding communication between devices. In one embodiment, machine learning model 134 may be a Long Short-Term Memory (LSTM) network. Long short-term memory networks are a type of recurrent neural network capable of learning order dependence in sequence prediction problems. This is a behavior required in complex problem domains like machine translation, speech recognition, and more.

Various embodiments, or portions of the embodiments, may be implemented in hardware or as instructions on a non-transitory machine-readable storage medium including any mechanism for storing information in a form readable by a machine, such as a personal computer, laptop computer, file server, smart phone, or other computing device. The non-transitory machine-readable storage medium may include volatile and non-volatile memories such as read only memory (ROM), random access memory (RAM), magnetic disk storage media, optical storage medium, flash memory, and the like. The non-transitory machine-readable storage medium excludes transitory signals.

Although the invention is described herein with reference to specific embodiments, various modifications and changes can be made without departing from the scope of the present invention as set forth in the claims below. Accordingly, the specification and figures are to be regarded in an illustrative rather than a restrictive sense, and all such modifications are intended to be included within the scope of the present invention. Any benefits, advantages, or solutions to problems that are described herein with regard to specific embodiments are not intended to be construed as a critical, required, or essential feature or element of any or all the claims.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements. The term “coupled,” as used herein, is not intended to be limited to a direct coupling or a mechanical coupling.

What is claimed is:

1. A method for detecting a fuzzing analysis in a first device, the method comprising:
receiving a new message of a message type from a second device;
predicting the message type of the new message from previously received messages;
determining the message type of the new message by analyzing the new message;
determining a likelihood that the predicted message type compares favorably to the determined message type of the new message;
determining that the predicted message type does not compare favorably to a threshold likelihood value; and
providing an indication of the fuzzing attack.

2. The method of claim 1, further comprising adding the determined message type of the new message to a stored list of previous messages in a memory of the first device.

3. The method of claim 1, wherein predicting the message type of the new message is performed using a machine learning model in the first device.

4. The method of claim 3, wherein the machine learning model comprises a long short-term memory (LSTM) neural network.

5. The method of claim 1, wherein the indication of the fuzzing attack is provided only after a plurality of unfavorable comparisons to the threshold likelihood value.

6. The method of claim 1, wherein the method is implemented in a program comprising instructions stored in a non-transient storage medium and executed by a processor in the first device.

7. The method of claim 6, wherein the method is capable of being disabled during software development in the first device.

8. The method of claim 1, wherein the message type of the new message is a request for data.

9. The method of claim 8, wherein the new message is a malformed request for data, and wherein the malformed request for data has a relatively low likelihood value.

10. The method of claim 1, wherein fuzzing analysis detection is enabled or disabled using a control bit stored in a memory.

11. A method for detecting a fuzzing analysis in a first device, the method comprising:
receiving a new message having a message type from a second device;
predicting the message type of the new message from previously received messages;
determining the message type of the new message by analyzing the new message;
determining a likelihood that the predicted message type compares favorably to the determined message type of the new message;
adding the determined message type of the new message to a stored list of previous messages in a memory of the first device;
determining that the predicted message type does not compare favorably to a threshold likelihood value; and
providing an indication of the fuzzing attack.

12. The method of claim 11, wherein predicting the message type of the new message is performed using a machine learning model in the first device.

13. The method of claim 12, wherein the machine learning model comprises a long short-term memory (LSTM) neural network.

14. The method of claim 11, wherein the indication of the fuzzing analysis is provided only after a plurality of unfavorable comparisons to the threshold likelihood value.

15. The method of claim 11, wherein the method is implemented in a program comprising instructions stored in a non-transient storage medium and executed by a processor in the first device.

16. The method of claim 15, wherein the method is capable of being disabled during software development in the first device.

17. The method of claim 11, wherein the message type of the new message is a request for data.

18. The method of claim 17, wherein the new message is a malformed request for data, and wherein the malformed request for data has a relatively low likelihood value.

19. The method of claim 11, wherein fuzzing analysis detection is enabled or disabled using a control bit stored in a memory.

20. The method of claim 11, wherein determining the message type of the new message by analyzing the new message further comprises using instruction execution circuitry of a processor to decode the new message to determine the message type.
